(19) United States
(12) Patent Application Publication
(10) Pub. No.: US 2019/0318204 A1
(43) Pub. Date: Oct. 17, 2019

(54) METHODS AND APPARATUS TO MANAGE TICKETS

(71) Applicant: Intel Corporation, Santa Clara, CA (US)

(72) Inventors: Yatish Mishra, Tempe, AZ (US); Cesar Martinez-Spessot, Cordoba (AR); Alexander Heinecke, San Jose, CA (US); Justin Gottschlich, Santa Clara, CA (US)

(21) Appl. No.: 16/452,040

(22) Filed: Jun. 25, 2019

(51) Int. Cl. G06K 9/62; G06N 20/00; G06Q 10/06

(52) U.S. Cl. CPC G06K 9/6257; G06Q 10/06316; G06N 20/00

(57) ABSTRACT

Methods and apparatus to manage tickets are disclosed. A disclosed example apparatus includes a ticket analyzer to read data corresponding to open tickets, a machine learning model processor to apply a machine learning model to files associated with previous tickets based on the read data to determine probabilities of relationships between the files and the open tickets, a grouping analyzer to identify at least one of a grouping or a dependency between the open tickets based on the determined probabilities, and a ticket data writer to store data associated with the at least one of the grouping or the dependency.

### FIELD OF THE DISCLOSURE

This disclosure relates generally to tickets used to manage projects and, more particularly, to methods and apparatus to manage tickets.

### BACKGROUND

In recent years, tickets, such as project management tickets, have been used to manage different aspects of projects and/or product development cycles. For example, the tickets are generated for change requests or feature implementations during the course of a project and/or a specific phase of the project. The tickets can be generated to be traceable with activities, resources, risk, schedule and cost. Further, from a project management perspective, the tickets can be monitored to determine or ascertain an overall status of the project.

Some managed projects utilize an automated regression system that generates tickets based on failures and/or problems encountered during a development cycle. In particular, for software development projects, when a software bug is introduced, a large set of regression tests can fail (e.g., due to multiple systems being tested) and the relationship, redundancies and/or commonalities between resultant tickets may not be apparent. The tickets can be numerous, thereby causing the triaging and organizing of the tickets to be difficult. As a result, significant amounts of time and labor may be spent viewing and analyzing the tickets in an attempt to triage and organize the tickets. Further, multiple related tickets that are redundant and/or overlapping can distort a status of a project, thereby resulting in an unjustified state of alarm.

### BRIEF DESCRIPTION OF THE DRAWINGS

FIG. 1 illustrates a known process flow associated with a project management tracking system.

FIG. 2 is a graph representing characterization of tickets associated with the known process flow of FIG. 1.

FIG. 3 represents tickets that can be managed by examples disclosed herein.

FIG. 4 is a block diagram of an example system constructed in accordance with teachings of this disclosure for managing tickets.

FIG. 5 is a flowchart representative of machine readable instructions which may be executed to implement the example ticket management system of FIG. 4.

FIG. 6 is a flowchart representative of machine readable instructions which may be executed to implement the example ticket management system of FIG. 4.

FIG. 7 illustrates an example trained network that can be implemented in examples disclosed herein.

FIG. 8 illustrates a long short term memory (LSTM) network that can be implemented in examples disclosed herein.

FIG. 9 illustrates a cost function analysis that can be implemented in examples disclosed herein.

FIG. 10 is a block diagram of an example processing platform structured to execute the instructions of FIGS. 5 and/or 6 to implement the example ticket management system of FIG. 4.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Methods and apparatus to manage tickets are disclosed. In known systems, tickets (e.g., project management tickets) are generated and monitored to manage and/or observe the progress of different aspects of a project and/or associated development cycles of the project. In particular, tickets can be generated for change requests or feature implementations during the course of the project. Accordingly, these tickets are monitored to evaluate whether issues of the project are being resolved, as generally indicated by an overall number of open tickets, and to determine a general status of the project.

Some projects utilize an automated regression system that generates tickets corresponding to a failure and/or problem encountered during testing of a feature in software projects. When a software bug is introduced, a large set of regression tests can fail and the relationship between resultant tickets may not be readily apparent. In particular, redundant and overlapping tickets can be numerous, thereby making the tickets difficult to be properly triaged and organized. As a result, significant amounts of time and labor can be spent in an attempt to triage and organize the tickets. Further, a large number of related, overlapping and/or interrelated tickets can distort a progress overview of a project.

Examples disclosed herein utilize deep learning with neural networks to facilitate triage and organization of open tickets (e.g., recently opened, currently open, etc.), thereby resulting in a significantly more accurate view of a project. Examples disclosed herein utilize a trained machine learning model that can be used to generate grouping and/or dependencies of the open tickets based on files associated with previous tickets (e.g., tickets from a previous project or a previous phase of the same project, resolved tickets, closed tickets, earlier tickets from the same project phase, historical tickets, etc.). The aforementioned trained model is used to relate the open tickets to the files by determining probabilistic relationships therebetween. The trained model may be trained based on (e.g., solely based on) files related to open or resolved issues of the previous tickets.

In some examples, the trained model is developed using a long short term memory (LSTM) based network. In other examples, a gated recurrent unit (GRU) based network is implemented instead of the LSTM based network. In some examples, a cost function analysis is implemented to determine similarities between the open tickets.

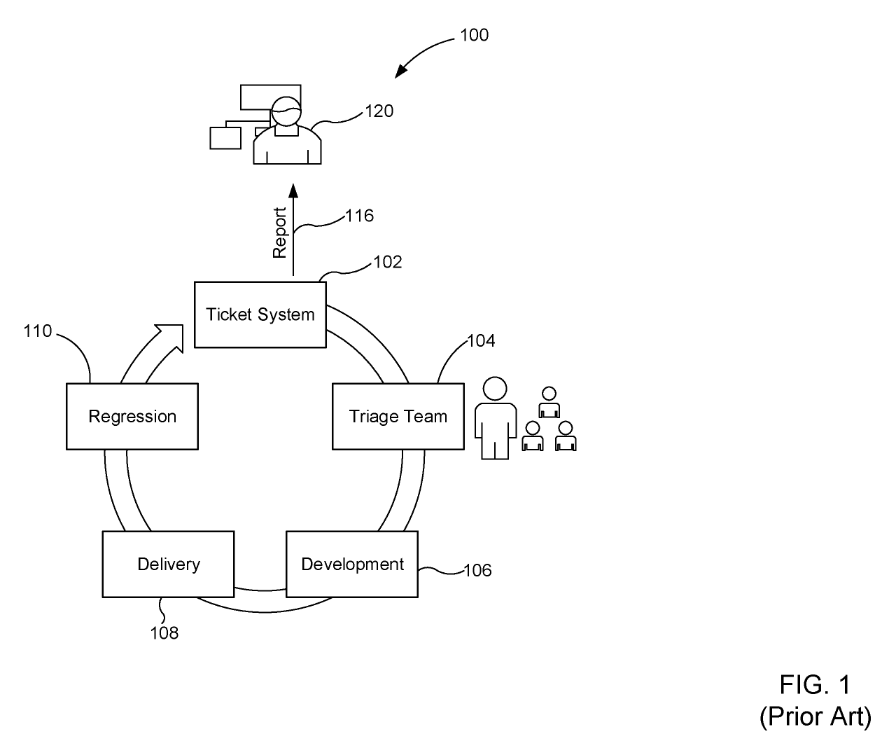

FIG. 1 illustrates a known process flow 100 associated with a project management ticket tracking system. The known process flow 100 includes a ticket system 102, a triage team 104, a development phase 106, a delivery phase 108, and a regression process 110. In this example, the ticket system 102 delivers reports (e.g., project reports) 116 to a project management system and/or organization (e.g., a project management team) 120.

In operation, the ticket system 102 issues, opens and/or generates tickets (e.g., support tickets) to be provided to the triage team 104. In particular, these tickets are herein referred to as open tickets and can correspond to a task, an issue to be fixed, a product feature to be implemented, documentation to be created, etc. The triage team 104 reviews the open tickets and, in turn, combines and/or organizes the open tickets. The review process can be time-consuming because after review of the numerous open tickets, the triage team 104 then subsequently groups related tickets and assigns the open tickets to developers and/or development teams of the development phase 106. In turn, during the delivery phase 108, deliverables associated with the open tickets are deployed or released by the developers and/or the development teams. In the regression phase 110, the changes associated with the open tickets are tested and/or implemented to generate new open tickets, which may be based on newly introduced issues (e.g. bugs) for example. Accordingly, the new open tickets are provided to the ticket system 102 and the cycle repeats. Further, at least some of the tickets designated as open can now be closed.

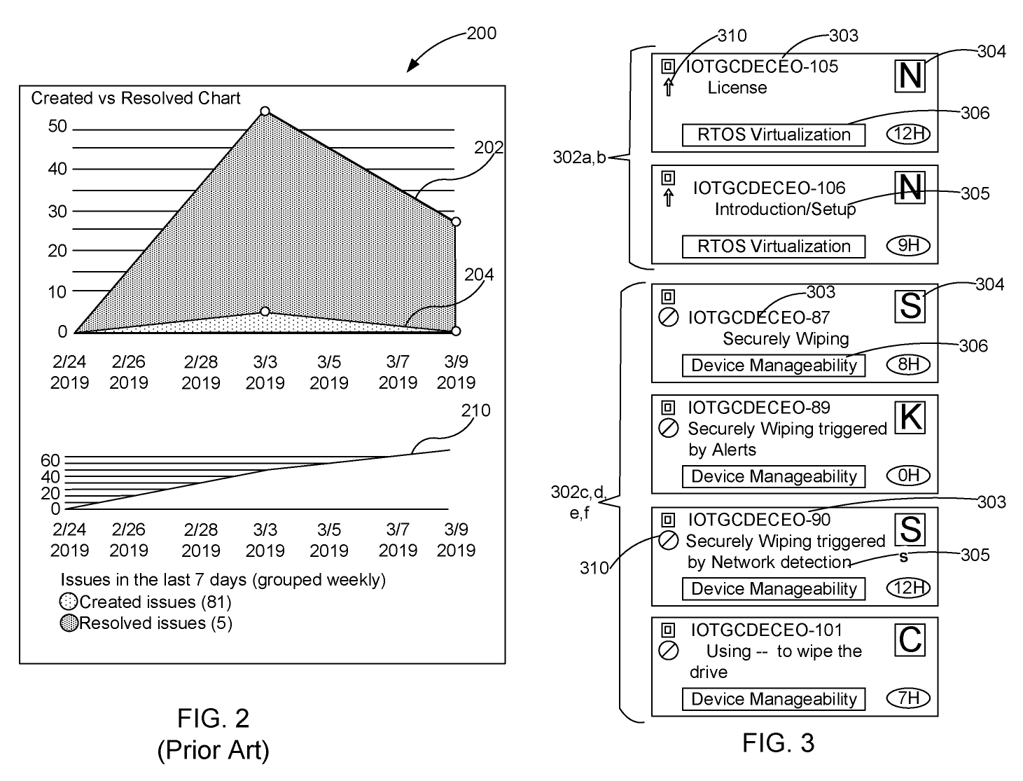

FIG. 2 is a graph 200 representing characterization of tickets associated with the known process flow 100 of FIG. 1. The graph 200 is generally referred to as a ticket burn down chart and represent an overview of a project that might be utilized by (e.g., viewed by) the project management organization 120 shown in FIG. 1. A curve 202 corresponds to a number of tickets of created/generated issues and a curve 204 corresponds to a number of tickets of resolved issues. Further, a curve 210 corresponds to a number of open and/or unresolved tickets.

Because multiple related tickets can be issued or opened for a single problem when tickets are redundant and/or overlap, an inaccurate increase in open tickets may be indicated by the curve 210 and/or the curve 202. In particular, the increase in tickets can inaccurately indicate that the associated project is undergoing a large increase in issues. This inaccurate indication can cause needless alarm that would be avoided if the tickets were properly grouped and/or combined. However, grouping and/or combining related tickets by the triage team 104 of FIG. 1 can take significant time, manpower and, thus, cost, especially when a relatively large number of tickets is involved.

In contrast, examples disclosed herein can be implemented to group and/or correlate related tickets, thereby enabling a more accurate indication of a status of a project. Examples disclosed herein can also facilitate more effective organization, combining and sorting of the tickets, all of which can improve a reliability of correctly assigning the ticket. Accordingly, examples disclosed herein can more accurately and quickly generate correlations and/or dependencies of multiple tickets, thereby saving time and labor often associated with organizing and/or managing the tickets.

FIG. 3 represents tickets that can be managed by examples disclosed herein. As can be seen in FIG. 3, tickets 302 (hereinafter 302a, 302b, 302c, 302d, 302e, 302f, etc.) are depicted in a visual view (e.g., a user interface view). In the illustrated view of FIG. 3, sections 303 refer to a ticket name or identifier while letters 304 refer to an assigned developer. Further, portions 305 refer to a specified task and/or feature to be implemented while portions 306 indicate a ticket category. Further, indicators 310 are used to show a priority level and/or status of the associated ticket 302.

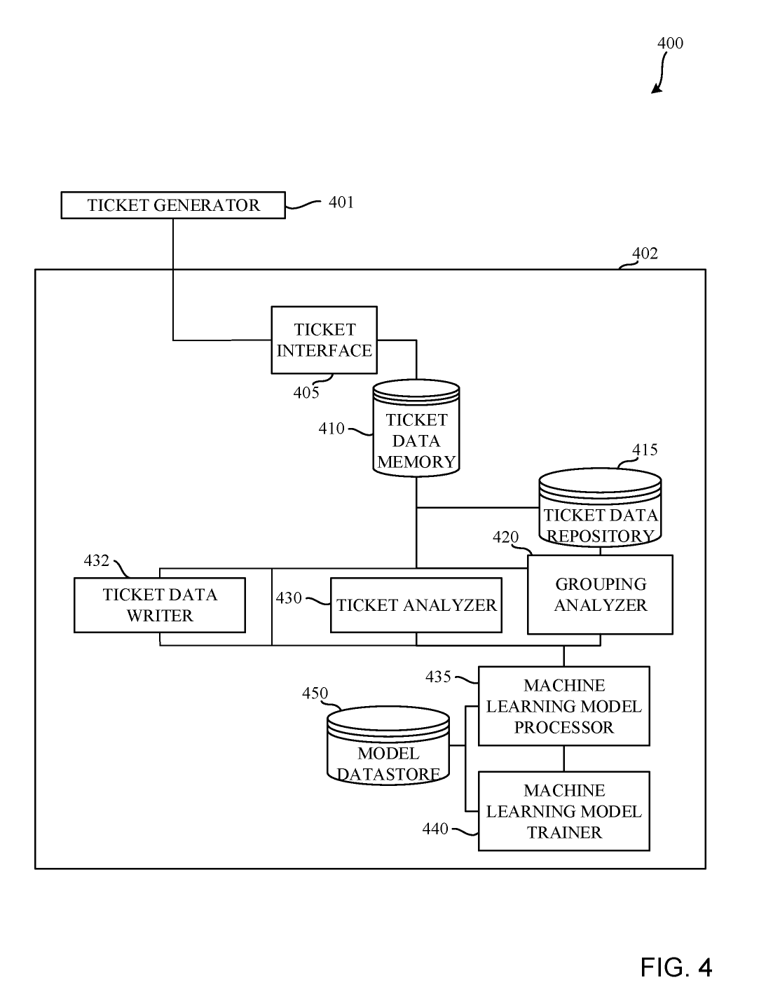

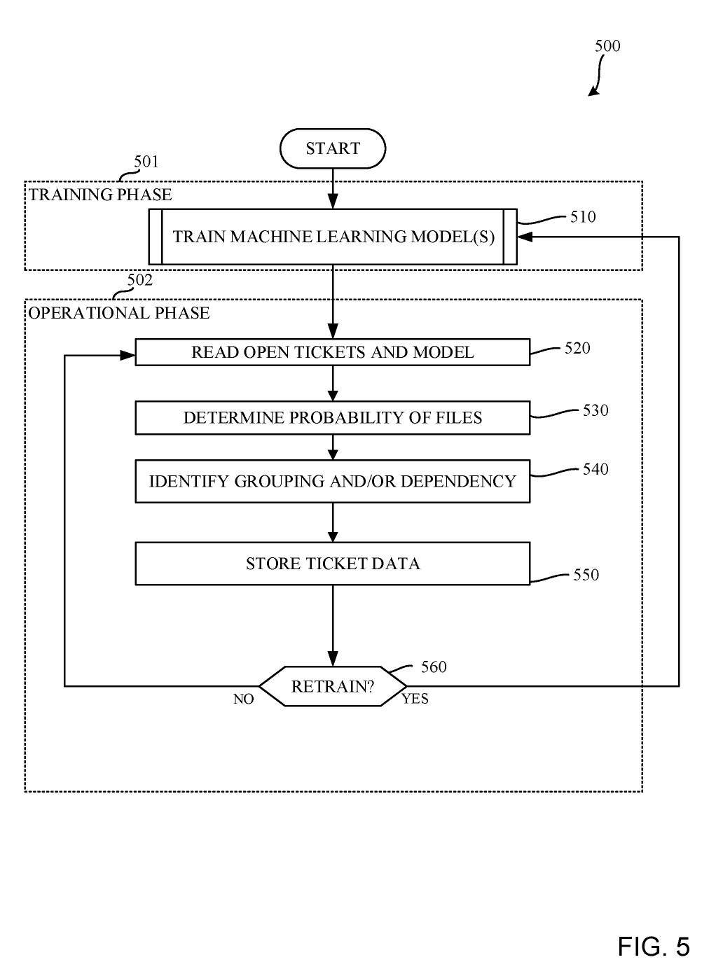

FIG. 4 is a block diagram of an example system 400 constructed in accordance with teachings of this disclosure for managing tickets. The ticket management system 400 of the illustrated example includes a ticket generator 401 and a ticket management analyzer 402. The example ticket management analyzer 402 includes an example ticket interface 405, an example ticket data memory 410, an example ticket data repository 415, an example grouping analyzer 420, an example ticket analyzer 430, an example ticket data writer 432, an example machine learning model processor 435, an example machine learning model trainer 440 and an example model datastore 450.

In the illustrated example, the ticket generator 401 generates and/or creates open tickets (e.g., regression tickets, open issue tickets, feature requests, requested fixes, etc.). In this example, the ticket generator 401 generates the open tickets based on encountered issues that arise from testing a software implementation. For example, the open tickets can pertain encountered issues that encompass output errors and/or observed problems with the software implementation.

In some examples, the ticket interface 405 is implemented to receive the open tickets from the ticket generator 401 and parse content from the open tickets. For example, the ticket interface 405 parses and/or sorts text content data associated with the open tickets. Accordingly, the ticket interface 405 provides the open tickets and/or data associated with the open tickets to the ticket data memory 410 and/or the ticket data repository 415. In this example, the ticket data repository 415 also stores data pertaining to previously closed tickets (e.g., from previous projects), which are herein collectively referred to as stored previous tickets and/or previous tickets, and which may be open or closed. In some examples, only previous tickets or data related to the previous tickets that correspond to resolved issues are stored in the ticket data repository 415.

The ticket analyzer 430 of the illustrated example reads, extracts and/or analyzes data corresponding to the open tickets received at the ticket interface 405. Further, the example ticket analyzer 430 also reads in and/or retrieves the machine learning model from the model data store 450. In this example, the ticket analyzer 430 searches for and extracts data (e.g., text data, word syntax data, attribute codes, identifiers, etc.) that is associated with the open tickets, from the open tickets. In some examples, the data is extracted based on known fields and/or designated portions. In some examples, the ticket analyzer 430 re-formats and/or appends the aforementioned data to the open tickets.

The example machine learning model processor 435 applies a trained machine learning model to files associated with the previous tickets (e.g., tickets associated with a previous project) based on the data extracted from the open tickets. In particular, the example machine learning model processor 435 applies the machine learning model to the files to determine probabilities of a relationship (e.g., a relevancy) of ones of the files with each of the open tickets. In this example, the machine learning model processor 435 determines the probabilities based on a likelihood of whether the files pertain to a solution and/or resolution associated with the open tickets. Additionally or alternatively, the machine learning model processor 435 determines a probability of a relationship (e.g., a degree of relevancy) of the previous tickets in relationship to the open tickets based on the application of the trained machine learning model.

The aforementioned files can include code, code portions, resolution descriptions, code descriptions, requirement documents, executable programs, etc. stored in the example ticket data repository 415. The files can be associated with a previous project or a previous product development cycle. In some examples, the files include tickets and/or data associated therewith from a previous project and/or product development cycle. In some other examples, the files are associated with earlier tickets of the same product development cycle.

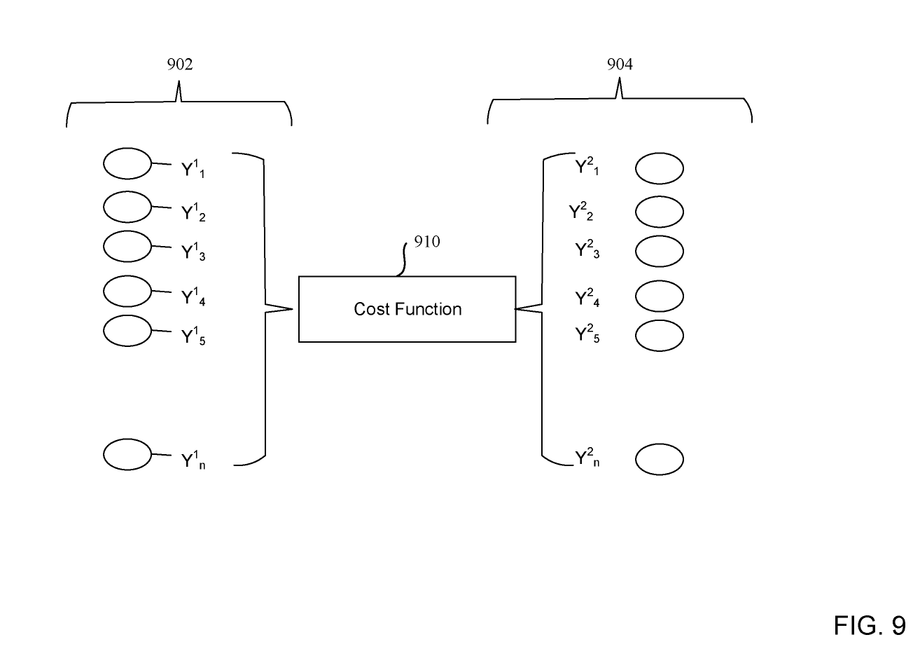

In the illustrated example, the grouping analyzer 420 identifies at least of a grouping or a dependency between the aforementioned open tickets based on the determined probabilities. In this example, the grouping analyzer 420 utilizes similarities of probable relationships between the files and the open tickets to associate and/or group the open tickets. For example, if a first open ticket of the open tickets is associated with a file A of the files to a requisite probability (e.g., a probability exceeding a threshold probability of a relationship) and a second open ticket of the open tickets is also associated with the file A to a requisite probability, the first and second open tickets are grouped together. In particular, the first and second open tickets can be combined into a single ticket or one of the first and second open tickets can be eliminated. As a result, a number of open tickets associated with overlapping or similar subject matter are reduced, thereby providing an accurate count of open tickets. Any number of tickets can be grouped together (e.g., two, five, one hundred, one thousand, etc.). Accordingly, large numbers of tickets can be grouped and/or associated, thereby saving significant manpower, associated overhead and, thus, costs. In some examples, the grouping analyzer 420 utilizes a cost model to generate dependencies and/or groupings amongst the open tickets. An example cost model (e.g., a cost function analysis) that can be implemented in examples disclosed herein is described in greater detail below in connection with FIG. 9.

Additionally or alternatively, the grouping analyzer 420 creates associations between the open tickets based on the aforementioned probabilities of a relationship without combining or eliminating any of the open tickets. In some such examples, open tickets corresponding to similar (e.g., similar groupings) or the same ones of the files are linked and/or associated with one another such that these open tickets can be assigned to the same developer, for example. Accordingly, while these associated open tickets may not be combined into a reduced number of open tickets in some examples, a number of open tickets indicated may be adjusted (e.g. lowered) to more accurately represent an effective number thereof.

The example ticket data writer 432 stores data associated with the grouping and/or the dependency between the open tickets. In this example, the ticket data writer 432 appends the data associated with the grouping and/or the dependency to the corresponding open tickets. In other words, the grouping and/or dependency data is stored onto the open tickets so that these open tickets convey the grouping and/or the dependency data, for example. Accordingly, in some examples, the ticket data writer 432 combines and/or eliminates some of the open tickets. Additionally or alternatively, the ticket data writer 432 generates and outputs a file (e.g., a file with tables, a summary file, etc.) with data pertaining to the grouping and/or dependency data.

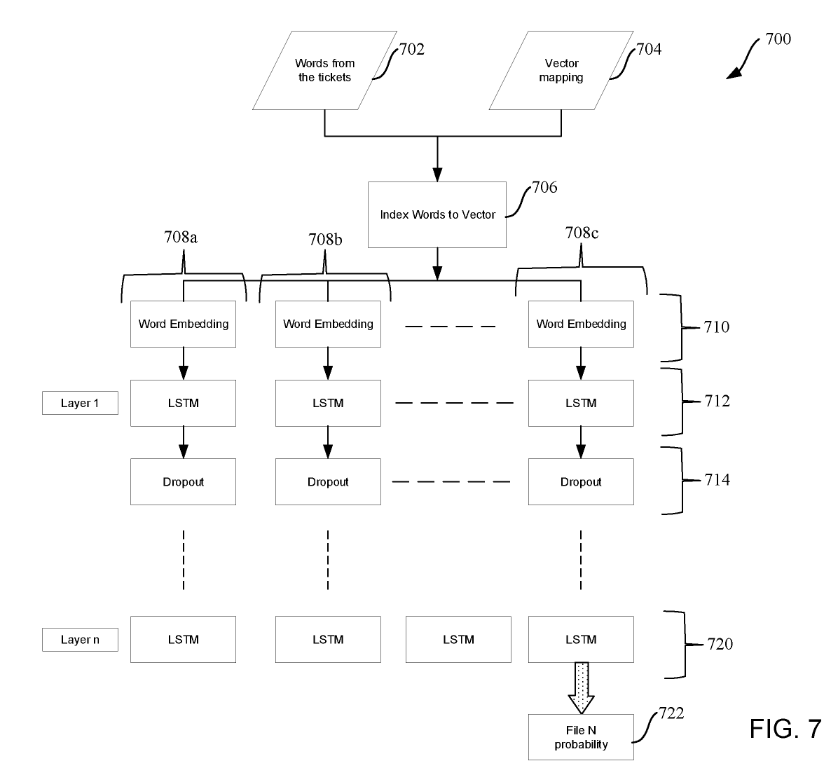

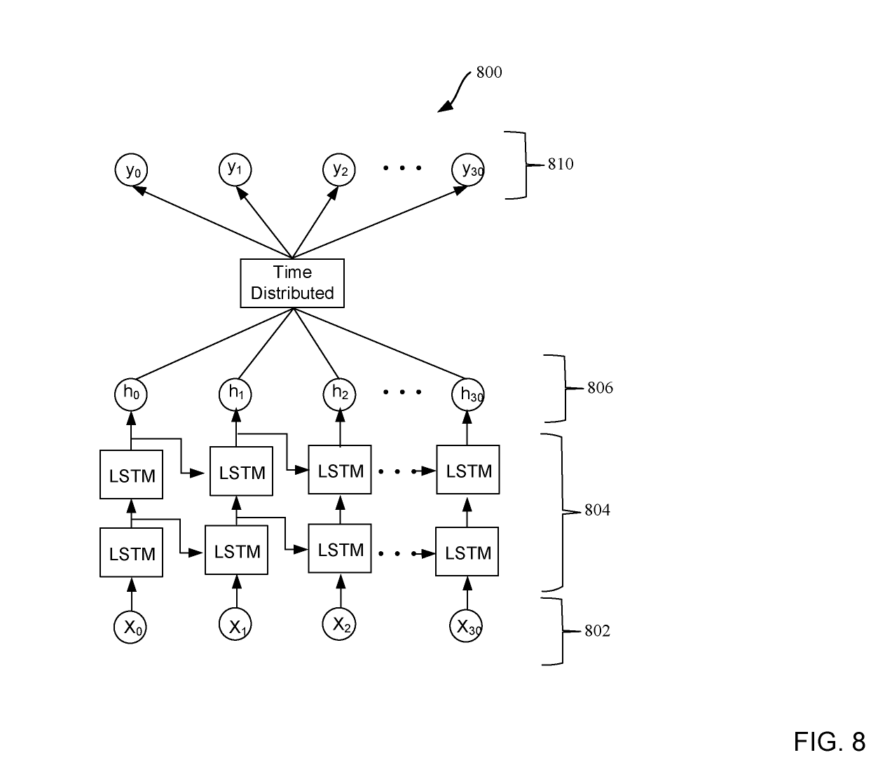

The machine learning model trainer 440 of the illustrated example trains the aforementioned machine learning model based on the previous tickets. The example machine learning model trainer 440 utilizes data from the previous tickets and trains the machine learning model so that the machine learning model can be utilized to predict the probabilities of relationships of the files to the open tickets. In this example, and as will be discussed in greater detail below in connection with FIGS. 7 and 8, the machine learning model is trained using an LSTM based network. However, any appropriate neural network, such as a GRU, for example, can be implemented instead. In this example, the machine learning model is trained over multiple projects (e.g., multiple related projects, etc.) and is stored in the model datastore 450.

In some examples, when the previous tickets are read in by the machine learning model trainer 440, a first value (e.g., 0%) is assigned to some or all of the previous tickets. Further, a second value (e.g., 100%) is assigned to the previous tickets that pertain to resolved and/or closed issues. In some such examples, the assigned first and second values are used to facilitate training the machine learning model.

While the example machine learning model of FIG. 4 is trained by the machine learning model trainer 440 over the course of multiple projects (e.g., product development projects, revision implementation projects, etc.), in some other examples, the machine learning model is trained over the course of a single project. In some such examples, sufficient data is gathered over the course of the project to train the machine learning model.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, an LSTM model is used. Using an LSTM model enables effective analysis and association of words associated with tickets and/or their related files. In general, machine learning models/architectures that are suitable to use in the example approaches disclosed herein will be a GRU-based training system, or any other appropriate approach. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using files associated with previous tickets and/or the previous tickets However, any other training algorithm may additionally or alternatively be used. In examples disclosed herein, training is performed until a dropout phase of an LSTM. In examples disclosed herein, training is performed at machine learning model trainer 440. Training may be performed on hyperparameters that control how the learning is performed (e.g., a learning rate, a number of layers to be used in the machine learning model, etc.).

Training is performed using training data. In examples disclosed herein, the training data originates from previous projects and/or previous tickets. Because supervised training is used, the training data is labeled. Labeling is applied to the training data by the machine learning model 440. In some examples, the training data is pre-processed.

Once training is complete, the model is deployed for use as an executable construct that processes an input and provides an output based on the network of nodes and connections defined in the model. The model is stored at the training model repository 415. The model may then be executed by the machine learning model processor 435.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

While an example manner of implementing the ticket management system 400 of FIG. 4 is illustrated in FIG. 4, one or more of the elements, processes and/or devices illustrated in FIG. 4 may be combined, divided, re-arranged, omitted, eliminated and/or implemented in any other way. Further, the example ticket interface 405, the example grouping analyzer 420, an example ticket analyzer 430, an example ticket data writer 432, the example machine learning model processor 435, the example machine learning model trainer 440 and/or, more generally, the example ticket management system 400 of FIG. 4 may be implemented by hardware, software, firmware and/or any combination of hardware, software and/or firmware. Thus, for example, any of the example ticket interface 405, the example grouping analyzer 420, an example ticket analyzer 430, an example ticket data writer 432, the example machine learning model processor 435, the example machine learning model trainer 440 and/or, more generally, the example ticket management system 400 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, ticket interface 405, the example grouping analyzer 420, an example ticket analyzer 430, an example ticket data writer 432, the example machine learning model processor 435, and/or the example machine learning model trainer 440 is/are hereby expressly defined to include a non-transitory computer readable storage device or storage disk such as a memory, a digital versatile disk (DVD), a compact disk (CD), a Blu-ray disk, etc. including the software and/or firmware. Further still, the example ticket management system 400 of FIG. 4 may include one or more elements, processes and/or devices in addition to, or instead of, those illustrated in FIG. 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

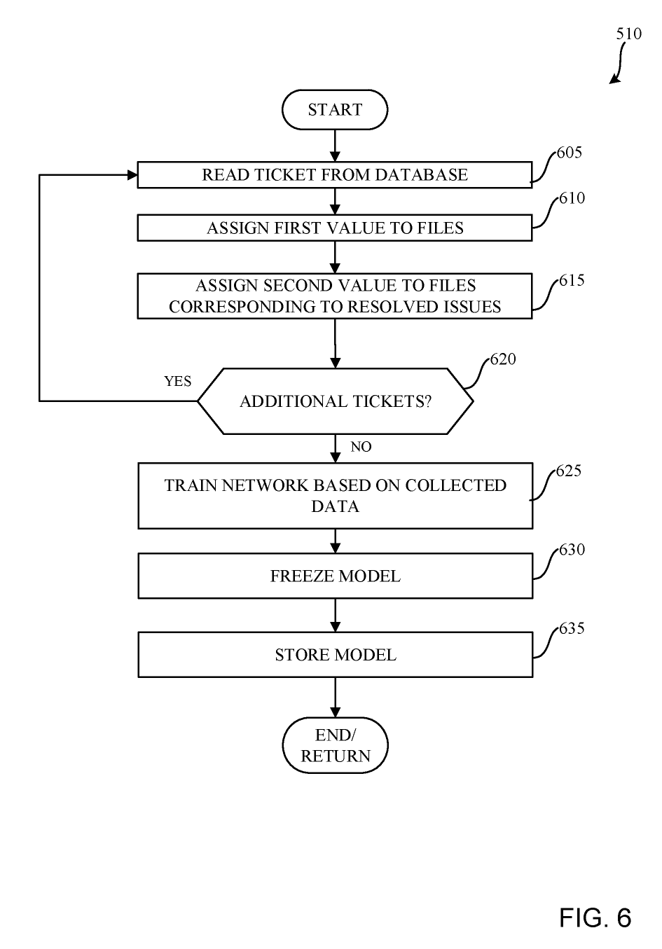

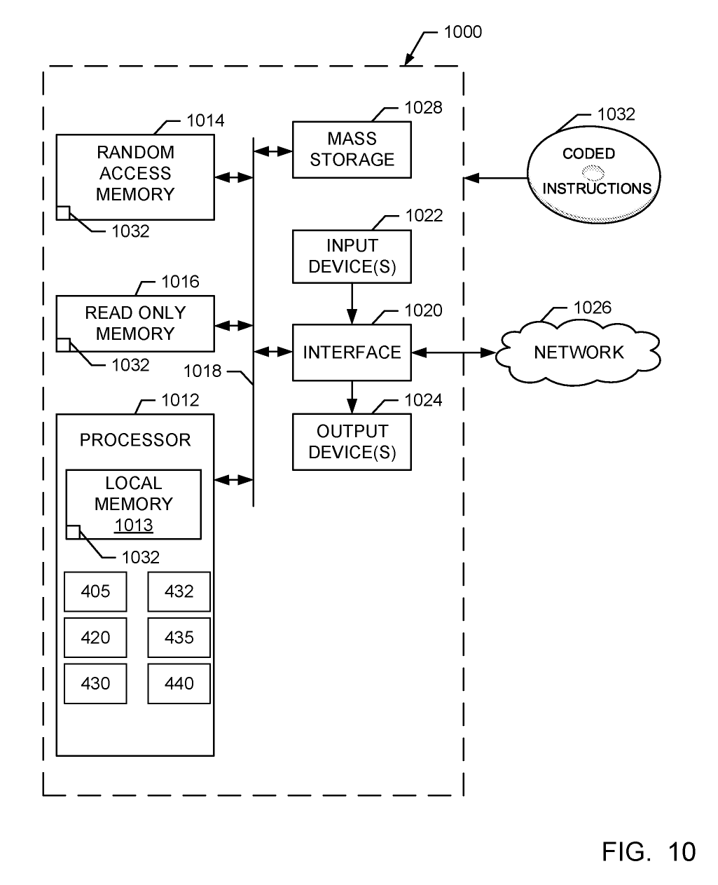

A flowchart representative of example hardware logic, machine readable instructions, hardware implemented state machines, and/or any combination thereof for implementing the ticket management system 400 of FIG. 4 is shown in FIGS. 5 and 6. The machine readable instructions may be one or more executable programs or portion(s) of an executable program for execution by a computer processor such as the processor 1012 shown in the example processor platform 1000 discussed below in connection with FIG. 10. The program may be embodied in software stored on a non-transitory computer readable storage medium such as a CD-ROM, a floppy disk, a hard drive, a DVD, a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 5 and 6, many other methods of implementing the example ticket management system 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5 and 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The example program 500 of FIG. 5 begins as a current development project (e.g., a hardware development project, a software development project, a software update project, a documentation project, etc.) is in progress. Accordingly, the current project is being monitored for an amount of open tickets that have been generated and/or created by the ticket generator 401. In this example, the current project follows a previous project that has been closed and successfully finished. However, in other examples, the previous project may still be open or in progress. The example program 500 includes a training phase 501 and an operational or inference phase 502.

At block 510, the machine learning model trainer 440 of the illustrated example trains the aforementioned machine learning model. In this example, the machine learning model is trained using an LSTM implementation.

At block 520, the example ticket analyzer 430 reads in and/or accesses the open tickets from the ticket data memory 410 and the machine learning model from the model datastore 450. In this example, the ticket analyzer 430 provides the open tickets to the machine learning model processor 435.

At block 530, the machine learning model processor 435 determines, generates and/or calculates a probability of the files being related to (e.g., relevant to) the open tickets by applying the machine learning model to the files using data associated with the open tickets. In this example, the probability corresponds to a likelihood of the files being related to the open tickets. For example, the machine learning model processor 435 determines a degree or a probability to which each one of the files, which may be stored in the ticket data repository 415, is related and/or relevant to the open tickets.

At block 540, the example grouping analyzer 420 identifies and/or generates groupings and/or dependencies between the open tickets based on the probabilities calculated by the machine learning model processor 435. In the illustrated example, the groupings and/or dependencies are generated based on a degree of how similar individual ones of the tickets correspond to the individual files. For example, open tickets that correspond to the same file(s), as indicated by the calculated probabilities, are grouped and/or associated, for example. Additionally or alternately, dependencies are created between open tickets that correspond to the same or similar file(s).

At block 550, the ticket data writer 432 stores data associated with the groupings and/or dependencies between the open tickets. In this example, at least one of the open tickets is appended with the data. Additionally or alternatively, a file is generated based on the data. In some examples, the ticket data writer 432 eliminates, sorts, combines and/or deletes at least some of the open tickets based on the aforementioned data.

At block 560, it is determined whether the machine learning model is to be retrained. If the machine learning model is to be retrained (block 560), control of the process returns to block 520. Otherwise, the process ends.

FIG. 6 is a flowchart representative of an example subroutine 510 of the example program 500 of FIG. 5. The subroutine 510 of the illustrated example corresponds to training the machine learning model.

At block 605, a previous ticket is read by the ticket interface 405 and/or the ticket generator 401. In this example, the previous ticket corresponds to a ticket from a previous project (e.g., a finished project, a previous phase of a project, a former development project, a former implementation project, a closed out project, etc.). The previous ticket can correspond to a ticket that is closed and/or resolved during the previous project.

In some examples, a first value (e.g., 0%) is assigned to the files (e.g., all of the files) associated with the former project (block 610). For example, each of the files can be initially assigned the first value before processing and/or sorting the files. In other words, all of the files can be initially assigned the first value.

In some examples, a second value (e.g., 100%) is assigned to files corresponding to resolved issues (block 615). In particular, the second value can be assigned to any tickets that are associated with a resolution (e.g., a successful resolution to a problem, etc.).

At block 620, it is determined whether there are additional tickets to be read from the database. If there are additional tickets to be read from the database (block 620), control of the process returns to block 605. Otherwise, the process proceeds to block 625.

At block 625, a network is trained based on collected data that is associated with tickets provided to the machine learning model. In this example, an LSTM network with layered LSTM nodes is implemented. However, any appropriate machine learning method may be employed instead.

At block 630, the machine learning model is frozen, in some examples. In particular, the machine learning model can be temporarily frozen until further tickets (e.g., previous tickets) are provided to the ticket interface 405, for example.

At block 635, the learning machine model is stored in the model datastore 450 and the process ends/returns.

FIG. 7 illustrates an example trained network 700 that can be implemented in examples disclosed herein. The trained network 700 is implemented with LSTM nodes in this example and utilizes words extracted from tickets 702. The trained network 700 also utilizes a vector mapping (e.g., a word to vector mapping) 704, an index 706 and branches 708 (hereinafter 708a, 708b, 708c, etc.). The example trained network 700 also utilizes a word embedding layer 710, a first layer of LSTM nodes 712, a drop out layer 714, and an nth-layer of LSTM nodes 720.

In operation, the words 702 of an open ticket are extracted by the ticket analyzer 430 and/or the ticket interface 405. Accordingly, the words 702 are converted to the index 706 based on the vector mapping 704. As a result, the branches 708 correspond to each file. In this example, word embedding is performed at the word embedding layer 710 and the first layer of LSTM nodes 712 performs the first LSTM analysis. In turn, the drop out layer 714 corresponds to a portion of the LSTM analysis that may be dropped, stopped and/or paused (e.g., to save computational resources), such that a probability result 722 corresponding to each of the files is outputted by the machine learning model processor 435. Further, multiple layers of the nth-layer of LSTM nodes 720 can be implemented. In this example, the probability result 722 is outputted to the cost function analysis described below in connection with FIG. 9.

In this example, the word embedding layer 710 is implemented. For example, each word from a corresponding ticket is mapped to a unique index. As a result, this index can be passed to the embedding layer 710 to obtain a word embedding matrix (e.g., a 50-dimensional matrix). An example of such a layer implementation is a global vectors for word representation (GloVe) mapping. Accordingly, the word embedding layer 710 can be initialized with a GloVe database and trained on unique and/or relevant wordings associated with or specific to the project. In this example, the embeddings are passed to multiple LSTM layers. In some examples, the number of layers and number of hidden unit cells may be dependent on a complexity of words present (e.g., words in a bug report). In some examples, a relatively larger network with a significant dataset works can be more effective than a relatively smaller network. Also, in some examples, a dense layer can be added to improve the accuracy of the trained network 700.

FIG. 8 illustrates an LSTM network 800 that can be implemented in examples disclosed herein. In particular, the LSTM network 800 includes inputs 802, LSTM layers (e.g., LSTM cells) 804, LSTM outputs 806 and a time distributed output 810. The example LSTM network 800 is time-based such that a time step can be increased depending on how verbose an individual ticket is. Accordingly the output 810 has a batch size, associated time steps and a resultant number of nodes to represent a respective probability of each of the files.

The LSTM network 800 is trained (e.g., initially trained) based on past closed tickets of a previous project, for example. The tickets can have information related to dependency among tickets, changes in files, etc. Currently, many typical projects are derived from (e.g., closely based on) a past project (e.g., files and/or tickets of a past project) and, thus, the past project can be used to train the LSTM network 800. In some examples, the number of inputs are dependent on how verbose a ticket is and/or a file size corresponding to the ticket. The number of outputs of the LSTM network 800 can be the same as a number of files (N), for example. Once the corresponding machine learning model has been trained by the LSTM network 800, the machine learning model can be used to predict probability of each of the files, all of which may possibly be relevant to a resolution of a ticket under consideration.

Since the machine learning model is trained on tickets that are generated by an automated system, such as the example ticket generator 401, the tickets can include standardized wording and the LSTM network 800 can, accordingly, be relatively effective in making predictions corresponding to generated tickets from the ticket generator 401.

FIG. 9 illustrates a cost function analysis that can be implemented in examples disclosed herein. In the illustrated example, the cost function analysis is implemented/executed by the example grouping analyzer 420 to determine a degree to which the open tickets are similar to one another based on their probabilistic relationship to the files associated with previous tickets (e.g., past tickets, closed tickets, resolved tickets, etc.). In particular, files 902 represent first relational probabilities of the same files in relation to a first open ticket while files 904 correspond to second relational probabilities of the files in relation to a second open ticket. Accordingly, a cost function 910 is used to determine a degree of similarity between the first and second open tickets based on the first and second relational probabilities, as generally shown below in Equation 1:

$$Cost function = \frac{\sqrt{{( {y}_{1 -}^{1} {y}_{1}^{2} )}^{2} + {( {y}_{2 -}^{1} {y}_{2}^{2} )}^{2} + … + {( {y}_{n -}^{1} {y}_{n}^{1} )}^{2}}}{n} \qquad ( 1 )$$

In this example, the similarity calculated by Equation 1 is compared to a threshold (e.g., a similarity threshold) to determine whether the first and second open tickets have a requisite similarity to be grouped, combined and/or associated (e.g., linked with one another). However, any appropriate calculation and/or metric can be used to determine a probabilistic similarity.

FIG. 10 is a block diagram of an example processor platform 1000 structured to execute the instructions of FIGS. 5 and 6 to implement the ticket management system 400 of FIG. 4. The processor platform 1000 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example ticket interface 405, the example grouping analyzer 420, an example ticket analyzer 430, an example ticket data writer 432, the example machine learning model processor 435, and the example machine learning model trainer 440.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), a Bluetooth® interface, a near field communication (NFC) interface, and/or a PCI express interface.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1020 of the illustrated example, thus, typically includes a graphics driver card, a graphics driver chip and/or a graphics driver processor.

The interface circuit 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives.

The machine executable instructions 1032 of FIGS. 5 and 6 may be stored in the mass storage device 1028, in the volatile memory 1014, in the non-volatile memory 1016, and/or on a removable non-transitory computer readable storage medium such as a CD or DVD.

Example 1 includes an apparatus comprising a ticket analyzer to read data corresponding to open tickets, a machine learning model processor to apply a machine learning model to files associated with previous tickets based on the read data to determine probabilities of relationships between the files and the open tickets, a grouping analyzer to identify at least one of a grouping or a dependency between the open tickets based on the determined probabilities, and a ticket data writer to store data associated with the at least one of the grouping or the dependency.

Example 2 includes the apparatus as defined in example 1, further including a machine model trainer to train the machine learning model based on the previous tickets.

Example 3 includes the apparatus as defined in example 2, wherein the machine model trainer implements a long short term memory (LSTM) network to train the machine learning model.

Example 4 includes the apparatus as defined in example 2, wherein the machine model trainer trains the machine learning model by assigning a first value to a first group of the files and a second value to a second group of the files corresponding to previously resolved issues.

Example 5 includes the apparatus as defined in example 1, wherein the previous tickets correspond to closed tickets of a previous project.

Example 6 includes the apparatus as defined in example 1, wherein the grouping analyzer is to implement a cost function analysis to identify the at least one of the grouping or the dependency.

Example 7 includes the apparatus as defined in example 1, wherein the ticket data writer is to append at least one of the open tickets with the data associated with the at least one of the grouping or the dependency.

Example 8 includes at least one non-transitory computer-readable medium comprising instructions, which when executed, cause at least one processor to at least apply a machine learning model to files associated with previous tickets based on read data corresponding to open tickets to determine probabilities of relationships between the files and the open tickets, identify at least one of a grouping or a dependency between the open tickets based on the determined probabilities, and store data associated with the at least one of the grouping or the dependency.

Example 9 includes the at least one non-transitory computer-readable medium as defined in example 8, wherein the instructions, when executed, cause the at least one processor to train the machine learning model based on the previous tickets.

Example 10 includes the at least one non-transitory computer-readable medium as defined in example 9, wherein a long short term memory (LSTM) network is used to train the machine learning model.

Example 11 includes the at least one non-transitory computer-readable medium as defined in example 9, wherein the machine learning model is trained by assigning a first value to a first group of the files and a second value to a second group of the files corresponding to previously resolved issues.

Example 12 includes the at least one non-transitory computer-readable medium as defined in example 8, wherein the previous tickets correspond to closed tickets of a previous project.

Example 13 includes the at least one non-transitory computer-readable medium as defined in example 8, wherein the instructions, when executed, cause the at least one processor to perform a cost function analysis to identify the at least one of the grouping or the dependency.

Example 14 includes the at least one non-transitory computer-readable medium as defined in example 8, wherein the instructions, when executed, cause the at least one processor to append at least one of the open tickets with the data associated with the at least one of the grouping or the dependency.

Example 15 includes a method comprising applying, by executing an instruction with at least one processor, a machine learning model to files associated with previous tickets based on read data corresponding to open tickets to determine probabilities of relationships between the files and the open tickets, identifying, by executing an instruction with the at least one processor, at least one of a grouping or a dependency between the open tickets based on the determined probabilities, and storing, by executing an instruction with the at least one processor, data associated with the at least one of the grouping or the dependency.

Example 16 includes the method as defined in example 15, further including training, by executing an instruction with the at least one processor, the machine learning model based on the previous tickets.

Example 17 includes the method as defined in example 16, wherein a long short term memory (LSTM) network is used to train the machine learning model.

Example 18 includes the method as defined in example 16, wherein the machine learning model is trained by assigning a first value to a first group of the files and a second value to a second group of the files corresponding to previously resolved issues.

Example 19 includes the method as defined in example 15, wherein the previous tickets correspond to closed tickets of a previous project.

Example 20 includes the method as defined in example 15, and further includes performing, by instructions executed with at least one processor, a cost function analysis to identify the at least one of the grouping or the dependency.

From the foregoing, it will be appreciated that example methods, apparatus and articles of manufacture have been disclosed that enable accurate and time-efficient management of tickets. Examples disclosed herein also enable more accurate indications of progress of a project. The disclosed methods, apparatus and articles of manufacture improve the efficiency of using a computing device by enabling tickets that would otherwise be redundant or overlapping to be combined and/or associated, thereby reducing computational overhaul usually associated with processing a relatively large number of tickets. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a ticket analyzer to read data corresponding to open tickets;
a machine learning model processor to apply a machine learning model to files associated with previous tickets based on the read data to determine probabilities of relationships between the files and the open tickets;
a grouping analyzer to identify at least one of a grouping or a dependency between the open tickets based on the determined probabilities; and
a ticket data writer to store data associated with the at least one of the grouping or the dependency.

2. The apparatus as defined in claim 1, further including a machine model trainer to train the machine learning model based on the previous tickets.

3. The apparatus as defined in claim 2, wherein the machine model trainer implements a long short term memory (LSTM) network to train the machine learning model.

4. The apparatus as defined in claim 2, wherein the machine model trainer trains the machine learning model by assigning a first value to a first group of the files and a second value to a second group of the files corresponding to previously resolved issues.

5. The apparatus as defined in claim 1, wherein the previous tickets correspond to closed tickets of a previous project.

6. The apparatus as defined in claim 1, wherein the grouping analyzer is to implement a cost function analysis to identify the at least one of the grouping or the dependency.

7. The apparatus as defined in claim 1, wherein the ticket data writer is to append at least one of the open tickets with the data associated with the at least one of the grouping or the dependency.

8. At least one non-transitory computer-readable medium comprising instructions, which when executed, cause at least one processor to at least:
apply a machine learning model to files associated with previous tickets based on read data corresponding to open tickets to determine probabilities of relationships between the files and the open tickets;
identify at least one of a grouping or a dependency between the open tickets based on the determined probabilities; and
store data associated with the at least one of the grouping or the dependency.

9. The at least one non-transitory computer-readable medium as defined in claim 8, wherein the instructions, when executed, cause the at least one processor to train the machine learning model based on the previous tickets.

10. The at least one non-transitory computer-readable medium as defined in claim 9, wherein a long short term memory (LSTM) network is used to train the machine learning model.

11. The at least one non-transitory computer-readable medium as defined in claim 9, wherein the machine learning model is trained by assigning a first value to a first group of the files and a second value to a second group of the files corresponding to previously resolved issues.

12. The at least one non-transitory computer-readable medium as defined in claim 8, wherein the previous tickets correspond to closed tickets of a previous project.

13. The at least one non-transitory computer-readable medium as defined in claim 8, wherein the instructions, when executed, cause the at least one processor to perform a cost function analysis to identify the at least one of the grouping or the dependency.

14. The at least one non-transitory computer-readable medium as defined in claim 8, wherein the instructions, when executed, cause the at least one processor to append at least one of the open tickets with the data associated with the at least one of the grouping or the dependency.

15. A method comprising:
applying, by executing an instruction with at least one processor, a machine learning model to files associated with previous tickets based on read data corresponding to open tickets to determine probabilities of relationships between the files and the open tickets;
identifying, by executing an instruction with the at least one processor, at least one of a grouping or a dependency between the open tickets based on the determined probabilities; and
storing, by executing an instruction with the at least one processor, data associated with the at least one of the grouping or the dependency.

16. The method as defined in claim 15, further including training, by executing an instruction with the at least one processor, the machine learning model based on the previous tickets.

17. The method as defined in claim 16, wherein a long short term memory (LSTM) network is used to train the machine learning model.

18. The method as defined in claim 16, wherein the machine learning model is trained by assigning a first value to a first group of the files and a second value to a second group of the files corresponding to previously resolved issues.

19. The method as defined in claim 15, wherein the previous tickets correspond to closed tickets of a previous project.

20. The method as defined in claim 15, further including performing, by executing an instruction with the at least one processor, a cost function analysis to identify the at least one of the grouping or the dependency.
